(19) United States
(12) Patent Application Publication
(10) Pub. No.: US 2012/0251195 A1
(43) Pub. Date: Oct. 4, 2012

(54) Image Forming Apparatus

(75) Inventor: Junki Ueyama, Nagoya-shi (JP)

(73) Assignee: BROTHER KOGYO KABUSHIKI KAISHA, Nagoya-shi (JP)

(21) Appl. No.: 13/432,605

(22) Filed: Mar. 28, 2012

(30) Foreign Application Priority Data
Mar. 29, 2011 (JP) 2011-072004

(51) Int. Cl. G03G 15/16

(52) U.S. Cl. 399/307

(57) ABSTRACT

An image forming apparatus includes a photoconductor member, and a transfer roller disposed to face the photoconductor member and allow the developer image to be transferred to a transfer-receiving member. A fixing device disposed downstream from the photoconductor member in a conveying direction and configured to fix the image formed on the transfer-receiving member, and a conveying path forming member disposed between the photoconductor member and the fixing device, and that forms a conveying path from the photoconductor member to the fixing device. The conveying path forming member includes first and second members which respectively extend from/to the photoconductor member to/from the fixing device. The second member crosses a second line which perpendicularly crosses a first line, which connects axes of the photoconductor member and the transfer roller, and passes through a contact area in which the photoconductor member and the transfer roller are configured to contact each other.

### CROSS REFERENCE TO RELATED APPLICATIONS

This application claims priority from Japanese Patent Application No. 2011-072004, filed on Mar. 29, 2011, the entire subject matter of which is incorporated herein by reference.

### BACKGROUND

1. Field

The disclosure relates to an electrophotographic image forming apparatus.

2. Description of the Related Art

An illustrative electrophotographic printer is provided with a photoconductor drum and a fixing device. The photoconductor drum carries a developer image thereon, which is to be transferred to a paper sheet. The transferred developer image is fixed with heat to the paper sheet by the fixing device.

For example, Japanese Unexamined Patent Application Publication No. 2007-226269 discloses a printer which is provided with a process unit and a fixing unit.

The process unit is provided with a photosensitive drum. The fixing unit is located on the rear side of and at some distance from the process unit. A paper sheet is conveyed linearly from the process unit to the fixing unit.

### SUMMARY

The printer mentioned above is provided with a guide near the lower side of a conveying path. The guide includes an upper surface which has a substantially linear cross section and extends along a conveying path in an area between the process unit and the fixing unit.

In such a configuration, the paper sheet can easily contact the guide during conveyance in the area between the process unit and the fixing unit and thereby, for example, the conveyance speed may be changed. If the conveyance speed of the paper sheet in the fixing unit becomes significantly lower than the conveyance speed in the process unit, the paper sheet may bunch up such in a wave-like manner, which may interfere with smooth conveyance of the paper sheet.

Certain aspects of the disclosure may provide an image forming apparatus which is capable of conveying a transfer-receiving member from a photoconductor drum to a fixing device smoothly even if there is a change in conveyance speed in the fixing device.

### BRIEF DESCRIPTION OF THE DRAWINGS

FIG. 1 illustrates, in a sectional view, a printer as an illustrative image forming apparatus according to the disclosure.

FIG. 2 illustrates, in a perspective view from the rear left side, a lower wall formation member illustrated in FIG. 1 with a cover member being removed.

FIG. 3 illustrates, in a perspective view from the rear left side, the lower wall formation member illustrated in FIG. 1 with the cover member being attached.

FIG. 4 illustrates, in a perspective view from the front left side, a fixing device and the lower wall formation member illustrated in FIG. 1.

FIG. 5 is an enlarged view of an area W of the printer illustrated in FIG. 1.

### DETAILED DESCRIPTION

### 1. Entire Configuration of Printer

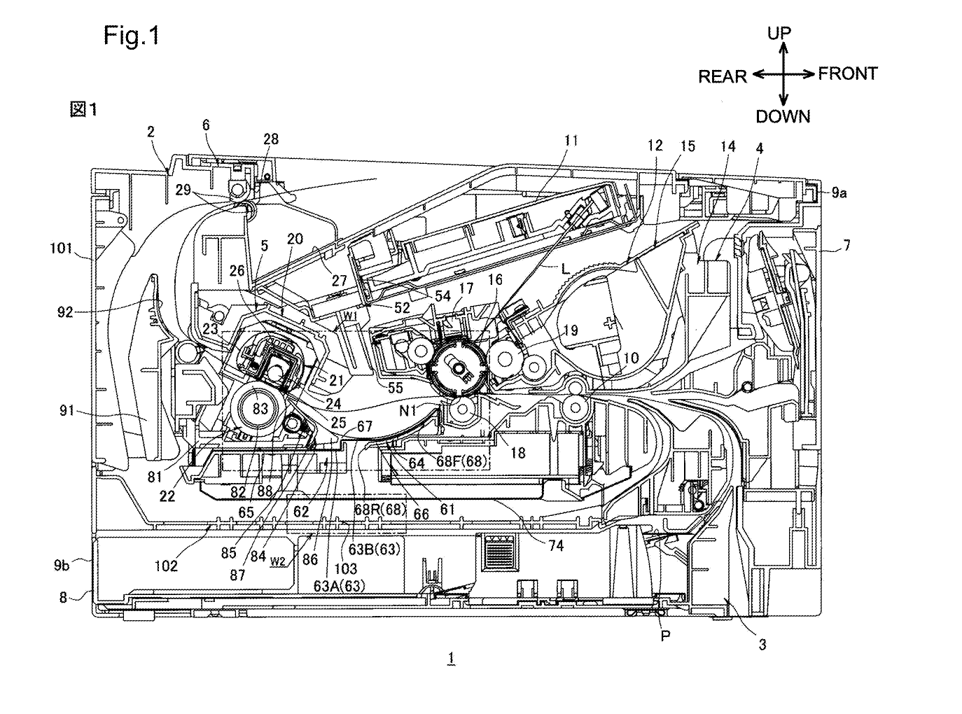

As illustrated in FIG. 1, an illustrative image forming apparatus in the form a printer 1 is provided with a paper feeding unit 3, an image forming unit 4, a fixing unit 5 and a paper sheet discharge unit 6 which are held in a main body casing 2.

A front cover 7 is provided on a side wall 9a on one horizontal end or a first side of the main body casing 2. The front cover 7 can be opened and closed for the removal and replacement of a process cartridge 12, which will be described below. A side wall 9b is provided on the other horizontal end or second side of the main body casing 2 facing the first side.

In the following description, the side of one horizontal end (the right side of FIG. 1 seen from above) at which the front cover 7 is provided is defined as the front side, and the side of the other horizontal end (the left side of FIG. 1 seen from above) opposite to the front side is defined as the rear side. The left side and right side of the printer 1 are defined with respect to the front side of the printer 1. In particular, the near side of FIG. 1 is the left side and the far side of FIG. 1 is the right side.

(1) Paper Feeding Unit

A transfer-receiving member such as paper feeding unit 3 is provided with a paper feed tray 8 which holds a paper sheet P thereon. The paper feed tray 8 may be located at a lower end inside the main body casing 2 and can be configured to be removed and replaced from the front side.

When a paper sheet feed roller (not illustrated) located above the front end of the paper feed tray 8 is driven to rotate, one paper sheet P at a time held in the paper feed tray 8 is transferred upward and turned, and conveyed toward a resist roller 10 along a paper sheet feeding side U-shaped path. The resist roller 10 is located on the front side of the photoconductor drum 16, which will be described below. When the resist roller 10 is driven to rotate, the paper sheet P is conveyed at predetermined times to the image forming unit 4 (i.e., to a contact area N1 of the photoconductor drum 16 and a transfer roller 18, which will be described below).

In particular, a leading end (i.e., a downstream end in the conveyance direction) of the turned paper sheet P is conveyed substantially horizontally from the front side (i.e., one horizontal end) side toward the rear (i.e., the other horizontal end) side.

(2) Image Forming Unit

The image forming unit 4 is provided with a scanner unit 11 and a process cartridge 12.

(2-1) Scanner Unit

The scanner unit 11 is located at an upper end inside the main body casing 2. The scanner unit 11 outputs a laser beam L corresponding to image data toward the photoconductor drum 16 of the process cartridge 12 and scans a surface of the photoconductor drum 16 with the laser beam L moved in one of the left and right directions at high speed.

(2-2) Process cartridge

The process cartridge 12 is located below the scanner unit 11. The process cartridge 12 may be provided with a drum cartridge 14 and a development cartridge 15. The development cartridge 15 can be attached to the drum cartridge 14 to be removable and replaceable.

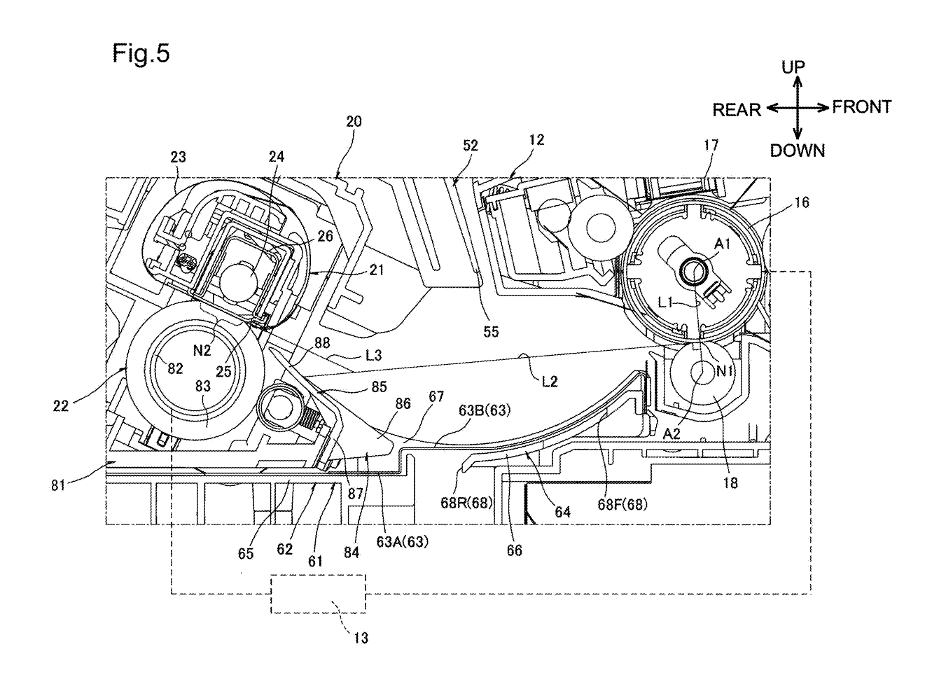

The photoconductor drum 16, which is substantially cylindrical in shape and extending in the left-right direction, is rotatably attached to the drum cartridge 14. The photoconductor drum 16 is driven to rotate by the driving force from a driving source such as motor 13 (see FIG. 5), which is provided in the main body casing 2.

The drum cartridge 14 is provided with a scorotron charging unit 17 and a transfer roller 18.

The development cartridge 15, which is located on the front side of the photoconductor drum 16, is provided with a developing roller 19.

The developing roller 19 is rotatably supported at the rear end of the development cartridge 15 to be exposed from the rear side. The developing roller 19 faces and contacts the photoconductor drum 16 to press the same from the front side.

Developing agent such as positively-charging non-magnetic single-component toner corresponding to each color can be stored in the development cartridge 15 and output via an opening the rear side to the developing roller 19.

(2-3) Development and Transfer

Toner in the development cartridge 15 is positively charged as the developing roller 19 is driven to rotate and is carried on a surface of the developing roller 19.

A surface of the photoconductor drum 16 is positively charged uniformly by the scorotron charging unit 17 as the photoconductor drum 16 is driven to rotate, and is then exposed to high-speed scanning with the laser beam L output by the scanner unit 11. In this manner, an electrostatic latent image corresponding to an image to be formed on the paper sheet P is formed on the surface of the photoconductor drum 16.

As the photoconductor drum 16 is driven to further rotate, the toner carried on the surface of the developing roller 19 is supplied to the electrostatic latent image formed on the surface of the photoconductor drum 16. Thus, the electrostatic latent image on the photoconductor drum 16 is visualized and a toner image produced by reversal development is carried on the surface of the photoconductor drum 16.

The toner image is transferred to the paper sheet P when the sheet P reaches the contact area N1 of the photoconductor drum 16 and the transfer roller 18.

(3) Fixing Unit

The fixing unit 5 is provided on the rear side (i.e., the side of the other horizontal end) of the process cartridge 12. The fixing unit 5 is provided with a fixing device 20.

The fixing device 20 is provided with a heating unit 21 and a roller member, for example a fixing roller 22.

The heating unit 21 is provided with heating film 23, a heating member 24, a nip plate 25 and a reflector plate 26.

The heating film 23, which is heat resistance and flexible, is formed in a substantially cylindrical shape extending in the left-right direction.

The heating film 23 is supported to be circumferentially rotatable in the fixing device 20 and is driven to rotate following the rotation of the fixing roller 22.

The heating member 24, which is a halogen lamp, is formed as a shaft extending in the left-right direction inside the heating film 23.

The nip plate 25 is formed as a substantially flat plate extending in the left-right direction, and is disposed between the heating member 24 and the heating film 23 so as to contact an inner surface of the heating film 23.

The reflector plate 26 has a substantially U-shaped cross section which is opened at a lower end thereof and extends in the left-right direction. The lower end of the reflector plate 26 engages the nip plate 25 from above to surround the nip plate 25 together with the heating member 24.

The nip plate 25, the reflector plate 26 and the heating member 24 are pressed against the fixing roller 22 in an integrated manner by an urging member (not illustrated).

The fixing roller 22 is provided with a hollow rotational axis 82 and a sponge roller 83 which surrounds the rotational axis 82. The fixing roller 22 is driven to rotate by the driving force from the motor 13 (see FIG. 5) which is shared by the photoconductor drum 16.

When the paper sheet P passes through between the heating film 23 and the fixing roller 22, the toner image on the paper sheet P is fixed to the paper sheet P with heat and pressure.

(4) Paper Sheet Discharge Unit

The paper sheet discharge unit 6 is provided with a paper output tray 27.

The paper output tray 27 is formed on an upper surface of the main body casing 2 as a substantially V-shaped recess which is opened at an upper end thereof. The paper sheet discharge unit 6 includes a paper sheet outlet 28 through which the paper sheet P is output.

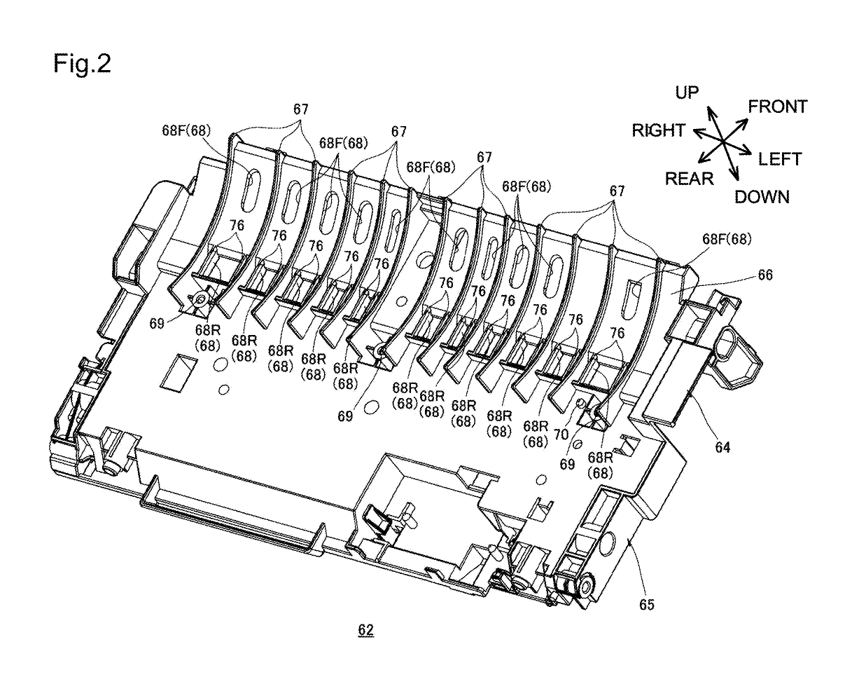

The paper sheet outlet 28 is formed in a substantially rectangular shape when seen in a front view (see FIG. 2) and extends in the left-right direction so as to penetrate a rear wall of the paper output tray 27 in the front-rear direction. A pair of output rollers 29 for conveying the paper sheet P to the paper output tray 27 is provided next to the paper sheet outlet 28. The output rollers 29, which are rotatable in the forward and backward directions, rotate forward to convey the paper sheet P to the paper output tray 27 and rotate backward to convey the paper sheet P to a second conveying path, which will be described below, inside the main body casing 2.

The paper sheet P having the toner image transferred thereto is conveyed between the output rollers 29 and is output to the paper output tray 27 through the paper sheet outlet 28 by the forward rotation of the output rollers 29.

### 2. Details of Conveying Path

(1) Lower Wall Formation Member

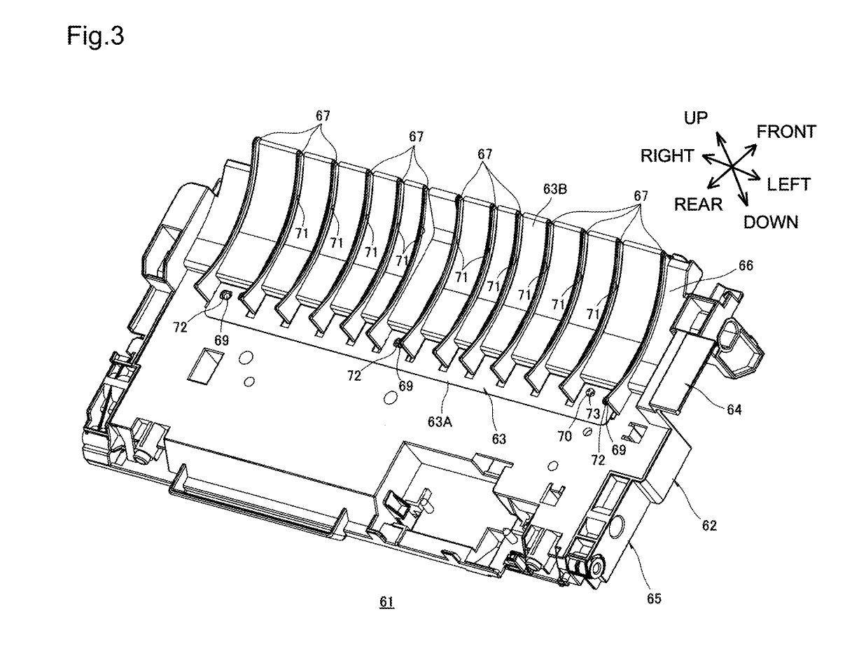

A lower wall formation member 61 (see FIG. 3) is provided in the main body casing 2 as illustrated in FIG. 1. The lower wall formation member 61 forms a lower wall of the conveying path, which will be described below, at a position above the paper feed tray 8 at some distance and between the photoconductor drum 16 and the fixing device 20.

The lower wall formation member 61 includes the frame 62 illustrated in FIG. 2 and a cover member 63 illustrated in FIG. 3 which is assembled to a front end of the frame 62 from above, and is formed as a substantially flat plate extending in the front-rear and left-right directions. A front end of the lower wall formation member 61 is located below a rear end of the photoconductor drum 16 (see FIG. 1). The lower wall formation member 61 is fixed between the left and right side walls (not illustrated) of the main body 2 at the left and right ends thereof.

The frame 62 can be made of resin (e.g., polystyrene). The cover member 63 can be made of metal.

The frame 62, formed as a substantially flat plate extending in the front-rear and left-right directions, is provided integrally with a fixing unit support 65 which supports the fixing device 20 and a first member such as a path formation member 64.

The fixing unit support 65 forms a rear half of the frame 62 and is formed as a substantially flat plate having predetermined thickness (i.e., length in the up-down direction). The fixing unit support 65 has substantially the same length in the front-rear direction as the fixing device 20 (see FIG. 1).

The path formation member 64 forms a front half of the frame 62 and is provided with a curved plate 66 and ribs 67. The curved plate 66 is curved upward as it approaches the front side. The ribs 67 are provided to protrude on the curved plate 66 extending in the front-rear direction. The path formation member 64 includes through holes 68 which penetrate the path formation member 64 in the up-down direction.

The curved plate 66 extends upward from a front end of the fixing unit support 65, bent toward the front side and curved upward with the predetermined curvature as it approaches the front side. That is, the curved plate 66 is downwardly curved with the rear end (i.e., the other horizontal end) being located at the lowest position and the front end (i.e., one horizontal end) being located at the highest position.

The ribs 67 are upward protrusions formed on the upper surface of the curved plate 66 and on an upper surface of the front end of the fixing unit support 65. The ribs 67 are arranged in parallel at certain intervals along the left-right direction. Upper end edges of the ribs 67 are curved with the same curvature as that of the curved plate 66. Rear ends (i.e., the other horizontal ends) of the ribs 67 are located further rearward than the rear end (i.e., the other horizontal end) of the curved plate 66. The upper end edges of the ribs 67 are curved upward as they approach the rear side.

The through holes 68 are arranged in series at the front end of the curved plate 66 and in series at the rear end of the curved plate 66 at certain intervals along the left-right direction. In the following description, the through holes 68 arranged on the front side will be referred to as front through holes 68F, and the through holes 68 arranged on the rear side will be referred to as rear through holes 68R.

Each of the front through holes 68F, formed as an elongated hole extending in the front-rear direction, is located between adjacent ribs 67 at the front end of the curved plate 66.

Each of the rear through holes 68R, formed as a substantially rectangular hole seen in a plan view, is located between adjacent ribs 67 at the rear end of the curved plate 66. In particular, the curved plate 66 is, at a portion between rear ends of adjacent ribs 67, divided into three sections by two partition plates 76 arranged in parallel at some distance from each other. One of the rear through holes 68R is formed to penetrate the curved plate 66 in the up-down direction at a position between the two partition plates 76 (i.e., a central section of the divided three sections). Sections between the rib 67 and the partition plate 76 (i.e., the left and right sections of the divided three sections) are closed.

In the frame 62, threaded holes 69 are formed at the front end of the fixing unit support 65 at positions of the left end, the right end and the center in the left-right direction. A substantially cylindrical positioning boss 70 protruding upward is formed near the left-side threaded hole 69.

The cover member 63 is curved to correspond to the shape of the path formation member 64 of the frame 62. In particular, the cover member 63 is provided integrally with a fixing unit 63A which is fixed to the front end of the fixing unit support 65, and a covering unit 63B which covers the path formation member 64 of the frame 62.

The fixing unit 63A is formed as a substantially flat plate extending in the left-right direction at the rear end of the cover member 63. In the fixing unit 63A, threaded insertion holes 72 are formed at the left end, the right end and the center in the left-right direction so as to correspond to the threaded holes 69 of the frame 62. In the fixing unit 63A, a positioning boss insertion hole 73, which is substantially round when seen in a plan view, is formed to penetrate the fixing unit 63A at a position near the left-side threaded insertion hole 72 to correspond to the positioning boss 70 of the frame 62. The positioning boss 70 of the frame 62 is inserted in the positioning boss insertion hole 73. Thus, the cover member 63 is positioned with respect to the frame 62 in the front-rear direction and in the left-right direction.

The covering unit 63B extends upward from the front end of the fixing unit 63A and further upward than the rear end of the curved plate 66. The covering unit 63B is curved upward as it approaches the front side with the same curvature as that of the curved plate 66 so as to face the curved plate 66 from above at some distance. That is, the covering unit 63B is also curved downward like the curved plate 66.

The covering unit 63B is bent downward at the front end thereof to correspond to the front end of the path formation member 64 and extends in the up-down direction.

Slits 71 extending in the front-rear direction are formed to penetrate the cover member 63 in the up-down direction. Each of the slits 71 corresponds to each of the ribs 67.

Each slit 71 has a width (i.e., the length in the left-right direction) greater than the thickness (i.e., the length in the left-right direction) of each rib 67, and has a length in the front-rear direction greater than the length of each rib 67. The slits 71 are arranged parallel to one another at certain intervals along the left-right direction.

The cover member 63 covers the curved plate 66 of the frame 62 such that each rib 67 of the frame 62 is located inside each slit 71 protruding upward from the cover member 63. In this state, the cover member 63 covers the curved plate 66 of the frame 62 such that no slit 71 overlaps any 68 when projected in the up-down direction.

In this state, the positioning boss 70 of the frame 62 is inserted in the positioning boss insertion hole 73 of the cover member 63, and each threaded insertion hole 72 of the cover member 63 and each threaded hole 69 of the frame 62 are positioned to face each other in the up-down direction.

The cover member 63 is fixed to the frame 62 with, for example, screws (not illustrated) each inserted in the threaded holes 69 via the threaded insertion holes 72.

The cover member 63 is electrically connected to the main body casing 2 via predetermined wiring and is grounded electrically via the main body casing 2.

(2) Fixing Device

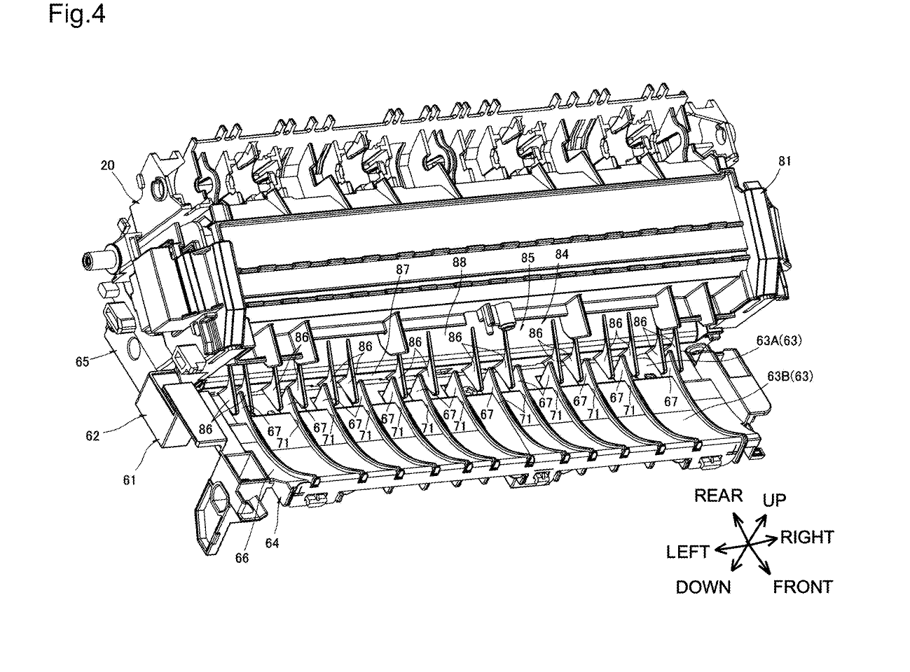

As illustrated in FIGS. 4 and 5, the fixing device 20 is located on the rear side of the path formation member 64 of the lower wall formation member 61 so as to be located above the fixing unit support 65 of the lower wall formation member 61. Both ends in the front-rear direction of the fixing device 20 are fixed to the fixing unit support 65 of the lower wall formation member 61. Both ends in the left-right direction of the fixing device 20 are positioned on the left-right direction side walls of the main body casing 2.

The fixing device 20 is provided with a fixing frame 81 which receives the heating unit 21 and the fixing roller 22.

The fixing frame 81 is formed as a substantial box-like shape extending in the left-right direction. The fixing frame 81 is opened at the front and rear sides of a contact area N2 in which the fixing frame 81 contacts the heating film 23 in the fixing roller 22.

The fixing frame 81 is provided with a second member, for example a fixing guide 84, which guides the paper sheet P to the front of the contact area N2. A conveying path forming member includes the fixing guide 84 together with the path formation member 64 of the lower wall formation member 61.

The fixing guide 84, extending to the front side, may be made of resin which is heat resistant and has triboelectric series which tends to be negatively charged in comparison with those of the paper sheet P and the toner (e.g., polyethylene terephthalate). The fixing guide 84 is provided with, at the front side of the fixing roller 22, a cover plate 85 which covers a lower front end of the fixing frame 81, and guide ribs 86 extending from the cover plate 85 to a lower front side.

The cover plate 85, which is substantially L-shaped when seen in a side view, is provided with a guide fixing unit 87 extending in the up-down direction and a guide unit 88 extending in the upper rear direction from the upper end of the guide fixing unit 87.

The guide fixing unit 87 is screwed to the lower front end of the fixing frame 81 from the front side.

The guide unit 88 is curved upward as it approaches the rear side with a curvature smaller than a curvature of the upper end edge of the rib 67. That is, the upper end edge of the rib 67 is curved with a curvature larger than a curvature of the upper end surface of the guide unit 88. The rear end of the guide unit 88 is located near the lower front side of the contact area N2, and the front end of the guide unit 88 is located near the rear side (i.e., the side of the other horizontal end) of each rib 67 of the lower wall formation member 61.

The guide unit 88 crosses a second line L2 which perpendicularly crosses a first line L1 so as to pass through the contact area N1 of the photoconductor drum 16 and the transfer roller 18 when projected in the left-right direction. The first line L1 connects an axis A1 of the photoconductor drum 16 and an axis A2 of the transfer roller 18.

In the fixing device 20, the heating unit 21 contacts the fixing roller 22 from the upper front direction such that the contact area N2 is inclined upward as it approaches the rear side.

That is, the tangent line L3 and the second line L2 cross each other to form an imaginary downward protrusion above the path formation member 64 of the lower wall formation member 61. The tangent line L3 makes contact with and is tangent to the center of the contact area N2 in the conveying direction (i.e., the upper rear side) of the paper sheet P. In particular, the second line L2 extends in the lower rear direction and the tangent line L3 extends in the lower front direction. The intersection point of the second line L2 and the tangent line L3 is located inside the curve of the first lower wall formation member 61 (i.e., inside the recess formed by the path formation member 64 and the fixing guide 84).

The guide ribs 86 protrude toward the front side from the front surface of the guide fixing unit 87 and from the front upper surface of the guide unit 88. Each of the guide ribs 86 is formed in a substantially triangular shape when seen in a side view having a vertex toward the lower front side. The guide ribs 86 are arranged in parallel at certain intervals along the left-right direction such that each of the guide ribs 86 is located between adjacent ribs 67 of the lower wall formation member 61. The guide ribs 86 are curved upward as they approach the rear side with a curvature smaller than a curvature of the upper end edges of the ribs 67. That is, the upper end edge of the ribs 67 are curved with a curvature larger than a curvature of upper end surfaces of the guide ribs 86.

The front end (i.e., one horizontal end) of the guide rib 86 overlaps the rear end (i.e., the other horizontal end) of each rib 67 of the lower wall formation member 61 when projected in the left-right direction, and is located further below the upper end edge of each rib 67 of the lower wall formation member 61.

(3) Paper Sheet Output Guide

As illustrated in FIG. 1, a paper sheet output guide 91 is provided on the rear side of the fixing device 20 in the main body casing 2. The paper sheet P which has passed the contact area N2 of the fixing device 20 is turned upward along the paper sheet output guide 91.

The paper sheet output guide 91 is formed as a substantially flat plate having thickness in the front-rear direction and extending in the up-down direction. The curved surface 92 which is curved upward as it approaches the rear side is formed at the upper end of the paper sheet output guide 91.

(4) Conveyance of Paper Sheet in Conveying Path

As described above, each paper sheet P is sent one at a time from the paper feed tray 8 to the resist roller 10 and is conveyed to the contact area N1 of the photoconductor drum 16 and the transfer roller 18 at predetermined times. After passing through the contact area N1, the paper sheet P is conveyed to the fixing device 20 and passes between the heating film 23 and the fixing roller 22. Then, the paper sheet P is turned upward along the paper sheet output guide 91 and is output to the paper output tray 27 through the paper sheet outlet 28 (the conveying path).

In particular, the paper sheet P, which is conveyed to the fixing device 20 after passing the contact area N1 of the photoconductor drum 16 and the transfer roller 18, is first conveyed in the rear direction substantially along the second line L2 following the rotation of the photoconductor drum 16.

Then, the rear end (i.e., the downstream end in the conveyance direction) of the paper sheet P contacts the guide unit 88 or the guide rib 86, is guided by the guide unit 88 in the upper rear direction and enters between the heating film 23 and the fixing roller 22.

Then, the paper sheet P is conveyed by rotation of the fixing roller 22 in the upper rear direction substantially along the tangent line L3.

In this state, the conveyance speed of the paper sheet P is set to be greater in the contact area N1 of the photoconductor drum and the transfer roller 18 than in the contact area N2 of the fixing roller 22 and the heating film 23.

In particular, the conveyance speed of the paper sheet P is slightly greater in the contact area N1 (i.e., the contact area of the photoconductor drum 16 and the transfer roller 18) which is in the conveying direction upstream than in the contact area N2 (i.e., the contact area of the fixing roller 22 and the heating film 23) which is in the conveying direction downstream. This setting is made to prevent the paper sheet P from being pulled during conveyance between the contact area N1 and the contact area N2.

Therefore, when the leading end (i.e., the downstream end in the conveyance direction) of the paper sheet P reaches the contact area N2, the paper sheet P is conveyed substantially along the second line L2 and the tangent line L3, but the paper sheet P can curl concavely or be loosened slightly downward as the paper sheet P is further conveyed. However, the amount of the curl or loosening of the paper sheet P is very small. Thus the conveyance path of the paper sheet does not substantially deviate from the line L2 and the tangent line L3 and the paper sheet P does not contact the path formation member 64.

That is, if the speed at which the photoconductor drum 16 conveys the paper sheet P and the speed at which the fixing roller 22 conveys the paper sheet P are almost the same, the paper sheet P is conveyed from between the photoconductor drum 16 and the transfer rollers 18 to the fixing device 20 at a distance above the path formation member 64.

It is possible that the sponge roller 83 of the fixing roller 22 has greater tolerance than, for example, metal parts. Since, as described above, the heating film 23 employs the heating unit 21, the fixing roller 22 instead of the heating unit 21 is driven to rotate.

It is therefore possible that a greater tolerance of the fixing roller 22 causes inconsistency in the conveyance speed of the paper sheet P. Thus, it is possible that, for example, the difference in conveyance speed of the paper sheet P in the contact area N1 and the contact area N2 is substantially larger than the expected conveyance speed and, as a result, the difference in speed in the contact area N1 and the contact area N2 can become substantially large.

The sponge roller 83 of the fixing roller 22 is vulnerable to heat, and thus it may expand when heated by the heating unit 21. The circumferential speed of the sponge roller 83 differs between a state in which it is expanded due to the influence of heat and a state in which it is not expanded due to any influence of heat. Such difference in circumferential speed may cause inconsistency in the conveyance speed of the paper sheet P.

That is, it is possible that, in the image forming apparatus provided with the fixing unit 5 which employs the heating film 23, the conveyance speed of the paper sheet P is not constant.

Even in such a case, since the path formation member 64 and the fixing guide 84 are downwardly curved, the paper sheet P is conveyed while being loosened downward or curling concavely.

### 4. Operation and Effect

(1) According to the printer 1, as illustrated in FIG. 5, the conveying path of the paper sheet P from the photoconductor drum 16 to the fixing device 20 includes the path formation member 64 of the lower wall formation member 61 and the fixing guide 84. The path formation member 64 of the lower wall formation member 61 extends from the photoconductor drum 16 toward the fixing device 20. The fixing guide 84 is provided in the fixing device 20 and extends from the fixing device 20 toward the photoconductor drum 16. The conveying path is downwardly curved from upper surfaces of the path formation member 64 and the fixing guide 84.

The fixing guide 84 crosses the second line L2 which perpendicularly crosses first line L1 which connects the axis A1 of the photoconductor drum 16 and the axis A2 of the transfer roller 18 so as to pass through the contact area N1 of the photoconductor drum 16 and the transfer roller 18.

Therefore, the paper sheet P which has passed the contact area N1 of the photoconductor drum 16 and the transfer roller 18 is conveyed substantially along the second line L2, brought into contact with the fixing guide 84, and then guided to the fixing device 20. That is, the paper sheet P is conveyed from the contact area N1 of the photoconductor drum 16 and the transfer roller 18 to the fixing device 20 at a distance from the path formation member 64.

If, for example, the conveyance speed of the paper sheet P in the fixing device 20 is changed greatly, i.e., becomes significantly lower than the expected conveyance speed of the paper sheet P in the photoconductor drum 16, the distance between the paper sheet P and the path formation member 64 allows the paper sheet P to curl concavely and be conveyed in a loosened manner. It is therefore possible that the paper sheet P can be conveyed smoothly from the photoconductor drum 16 to the fixing device 20 even if the conveyance speed of the paper sheet P in the fixing device 20 is changed significantly.

Since the guide unit 88 (i.e., the guide ribs 86) with which the leading end (i.e., the downstream end in the conveyance direction) of the paper sheet P is brought into contact is provided in the fixing frame 81, the leading end of the paper sheet P enters the contact area N2 of the fixing unit 5 with higher positional accuracy. Thus, the paper sheet P can be conveyed to the contact area N2 of the fixing unit 5 with high accuracy.

(2) According to the printer 1, the fixing guide 84 has triboelectric series which tends to be negatively charged in comparison with those of the paper sheet P and the toner.

It is therefore possible that the fixing guide 84 is charged, by the friction with the first paper sheet P, more negatively than the paper sheet P and the toner. Since the toner carried on the paper sheet P is attracted to the fixing guide 84 which tends to be negatively charged, the paper sheet P can be conveyed with the toner reliably carried thereon. That is, it is possible to reliably guide the second and subsequent paper sheets P and the toner to the fixing device 20 along the fixing guide 84 with the paper sheets P and the toner being attracted to the fixing guide 84.

(3) According to the printer 1, as illustrated in FIG. 5, the front end (i.e., one horizontal end) of each guide rib 86 of the fixing guide 84 is located further below the rear end (i.e., the other horizontal end) of the rib 67 of the path formation member 64.

Therefore, even if the paper sheet P which has passed the contact area N1 of the photoconductor drum 16 and the transfer roller 18 is brought into contact with the rib 67 of the path formation member 64 instead of the guide unit 88 or the guide ribs 86, the paper sheet P can be conveyed smoothly without being caught at the leading end thereof by the guide ribs 86.

(4) According to the printer 1, as illustrated in FIG. 5, the fixing device 20 is provided with the fixing roller 22 which is driven to rotate and the heating film 23 which circumferentially rotates around the heating member 24 following the rotation of the fixing roller 22.

In such a fixing device 20, the fixing roller 22 expands when heated by the heating member 24, which can cause reduction in rotational speed of the fixing roller 22.

However, according to the printer 1, as described above, even if the rotational speed of the fixing roller 22 is reduced, the distance between the paper sheet P and the path formation member 64 allows the paper sheet P to curl concavely and be conveyed in a loosened manner.

Therefore, it is possible to convey the paper sheet P smoothly from the photoconductor drum 16 to the fixing device 20 in the fixing device 20 even if the fixing roller 22 which is vulnerable to change in rotational speed is driven to rotate.

(5) According to the printer 1, as illustrated in FIG. 5, the tangent line L3 and the second line L2 cross each other to form an imaginary downward protrusion above the path formation member 64 and the fixing guide 84. The tangent line L3 contacts a center portion of the contact area N2 which is brought into contact with the heating film 23 in the fixing roller 22.

That is, it is possible that the paper sheet P which has passed the contact area N1 of the photoconductor drum 16 and the transfer roller 18 is conveyed substantially along the second line L2 and, then, is conveyed to the contact area N2 which contacts the heating film 23 in the fixing roller 22 substantially along the tangent line L3.

It is therefore possible to convey the paper sheet P along the imaginary protrusion formed by the tangent line L3 and the second line L2 and thus the paper sheet P is conveyed above the path formation member 64 at a distance.

(6) According to the printer 1, as illustrated in FIG. 5, the curvature of the ribs 67 of the path formation member 64 is greater than the curvature of the guide unit 88 and the guide ribs 86.

That is, the smaller curvature of the guide unit 88 and the guide rib 86 with which the leading end of the paper sheet P is brought into contact causes the shapes of the guide unit 88 and the guide ribs 86 to be nearly linear shapes. It is therefore possible to cause the leading end of the paper sheet P to reliably enter the contact area N2 of the fixing unit 5. The ribs 67 of the path formation member 64 have a large curvature so as to sufficiently absorb the loosening of the paper sheet P by allowing the paper sheet P to curl concavely. Thus, the loosening of the paper sheet P can be absorbed while conveying the paper sheet P in a reliable manner.

(7) According to the printer 1, as illustrated in FIG. 5, the photoconductor drum 16 and the fixing roller 22 are driven by the common motor 13.

Since the photoconductor drum 16 and the fixing roller 22 can be driven by a single motor 13, the simple-structured printer 1 can be obtained and the manufacturing cost can be lowered.

However, even if the conveyance speed of the paper sheet P in the fixing device 20 is changed, i.e., becomes significantly lower than the conveyance speed of the paper sheet P in the photoconductor drum 16, the conveyance speed of the paper sheet P in the fixing device 20 is changed and thus it is not possible to control the rotational speed of the fixing roller 22 independently.

In that respect, according to the printer 1 as described above, the distance between the paper sheet P and the path formation member 64 allows the paper sheet P to curl concavely and be conveyed in a loosened manner.

Therefore, the paper sheet P can be conveyed smoothly from the photoconductor drum 16 to the fixing device 20.

### 4. Modifications

(1) The paper sheet P is described as an illustrative transfer-receiving member in the above-described illustrative embodiment: however, other transfer-receiving members, such as an OHP sheet, may also be used.

(2) Polyethylene terephthalate is described as an illustrative material of the fixing guide 84 in the above-described illustrative embodiment: however, other resin having triboelectric series which tends to be negatively charged in comparison with the paper sheet P and the toner may also be used.

(3) The heating unit 21 of the fixing unit 5 employs the heating film 23 for the fixation in the above-described illustrative embodiment: however, for example, other fixing devices using a member other than a film to cover the heating member 24 (in particular, a fixing unit provided with a heat roller including a metal element tube for covering the heating member 24) may also be used.

(4) The fixing roller 22 is driven to rotate by the driving force from the motor 13 which is common with the photoconductor drum 16 in the above-described illustrative embodiment: however, the fixing roller 22 and the photoconductor drum 16 may have their own motor.

According to these modifications (1) to (4), it is possible to obtain the same operation and effect as those of the illustrative embodiment described above.

What is claimed is:

1. An image forming apparatus comprising:
a photoconductor member configured to carry a developer image to be transferred to a transfer-receiving member conveyed from a first side to a second side;
a transfer roller disposed to face the photoconductor member and allow the developer image to be transferred to the transfer-receiving member;
a fixing device disposed downstream from the photoconductor member in a conveying direction and configured to fix the image formed on the transfer-receiving member; and
a conveying path forming member disposed between the photoconductor member and the fixing device, and configured to form a conveying path of the transfer-receiving member from the photoconductor member to the fixing device, wherein the conveying path forming member, which has a concavely curved upper surface, includes:
a first member which extends from the photoconductor member to the fixing device; and
a second member which is provided at the fixing device and extends from the fixing device to the photoconductor member,
wherein the second member crosses a second line which perpendicularly crosses a first line, which connects an axis of the photoconductor member and an axis of the transfer roller, and passes through a contact area in which the photoconductor member and the transfer roller are configured to contact each other.

2. The image forming apparatus according to claim 1, wherein:
the transfer-receiving member includes a paper sheet; and
the second member has a relative tendency in a triboelectric series to be negatively charged relative to the paper sheet and a developing agent.

3. The image forming apparatus according to claim 1, wherein:
a downstream side of the first member in a conveying direction and an upstream side of the second member in the conveying direction overlap each other in the axial direction; and
the upstream side of the second member in the conveying direction is located below the downstream side of the first member in the conveying direction.

4. The image forming apparatus according to claims 1, wherein the fixing device includes:
a roller member configured to be driven to rotate;
a heating member disposed to face the roller member and be spaced apart some distance; and
heating film which contacts the roller member and configured to be driven to rotate around the heating member following the rotation of the roller member.

5. The image forming apparatus according to claim 4,
wherein the roller member has a contact area at which the heating film contacts the roller member, and wherein a third line, having a tangent which contacts a center portion of the contact area in the conveying direction, and the second line cross each other to form an imaginary downward protrusion above the path formation member.

6. The image forming apparatus according to claim 1, wherein an upper surface of the first member has a predetermined curvature which is greater than a curvature of an upper surface of the second member.

7. The image forming apparatus according to claim 1, further comprising a driving source configured to drive the photoconductor member and the fixing device.
